(19) United States
(12) Patent Application Publication
(10) Pub. No.: US 2026/0251099 A1
(43) Pub. Date: Aug. 27, 2026

(54) THERMAL MANAGEMENT SYSTEM, METHOD, AND APPARATUS FOR AN INTERNAL COMBUSTION ENGINE

(71) Applicant: Cummins Inc., Columbus, IN (US)

(72) Inventors: Russell Khajuria, Jammu (IN); Sujay Sudhir Kulkarni, Pune (IN)

(21) Appl. No.: 19/059,938

(22) Filed: Feb. 21, 2025

(51) Int. Cl. F02D 35/02

(52) U.S. Cl. CPC F02D 35/02

(57) ABSTRACT

A system, method, and apparatus for thermally managing an internal combustion engine are provided. A restart time for the engine is determined based on one or more temperature conditions associated with the internal combustion engine when the engine is shut down. After elapse of the restart time, the engine is automatically restarted if temperature conditions indicate an engine restart is required. The engine is then automatically shut down when a desired temperature of the engine is reached, and new restart time is estimated.

### TECHNICAL FIELD

The present application is related to internal combustion engines, and more particularly to systems and methods for thermally managing internal combustion engines to prevent or mitigate cold soak conditions.

The ability to start internal combustion engines during cold weather conditions can be difficult due to, for example, cold soak of the engine and engine components over time after the engine is shut down. To mitigate this cold soak issue and prevent the internal combustion engine and its components from decreasing in temperature to ambient temperature conditions, some users allow the engine to run for extended periods of time when the engine is otherwise not required to be operating. This results in additional fuel consumption and increased operating hours on the engine. There is therefore a need for additional improvements in this area.

### DISCLOSURE OF EXAMPLE EMBODIMENTS

For the purposes of clearly, concisely, and exactly describing example embodiments of the present disclosure, the manner, and method of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention includes and protects such alterations, modifications, and further applications of the example embodiments as would occur to one skilled in the art.

### SUMMARY

One embodiment of the present is a unique system for mitigating cold soak conditions of an internal combustion engine by managing starting and stopping of the engine during a shut down period in which the internal combustion engine is not operating. Another embodiment is a unique method for mitigating cold soak conditions of an internal combustion engine by managing starting and stopping of the engine during the shut down period. Another embodiment is a unique apparatus for mitigating cold soak conditions of an internal combustion engine by managing starting and stopping of the engine during the shut down period. Further embodiments, forms, objects, features, advantages, aspects, and benefits shall become apparent from the following description and drawings.

### BRIEF DESCRIPTION OF THE DRAWINGS

FIG. 1 is a schematic representation of an internal combustion engine system according to an embodiment of the present disclosure.

FIG. 2 is a block diagram of exemplary electronic control system according to an embodiment of the present disclosure.

FIG. 3 is a schematic flow diagram of an exemplary process for mitigating cold soak conditions of an internal combustion engine by managing starting and stopping of the engine during a shut down period.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DESCRIPTION OF THE ILLUSTRATED EMBODIMENTS

FIG. 1 is a schematic representation of an internal combustion engine system 100. As shown, the internal combustion engine system 100 includes an internal combustion engine 102, an intake system 104, an exhaust system 106, a motor system 108, an electronic control system 110, and an electrical energy storage system 112, among other components. It shall be appreciated that the illustrated configuration and components of the internal combustion engine system 100 are but one example, and that the disclosure contemplates that a variety of different internal combustion engine systems 100 and the associated components may be utilized.

Any type of internal combustion engine 102 may be used in internal combustion engine system 100, such as two-stroke and four-stroke types of engines. Further, the engine 102 may be fueled by a liquid fuel, such as, for example, diesel fuel or gasoline, and/or by a gaseous fuel, such as natural gas, hydrogen, bio-gas, methane, propane, ethanol, producer gas, field gas, liquefied natural gas, compressed natural gas, or landfill gas. However, other types of liquid and gaseous fuels are not precluded. Operation of engine 102 may cause the rotational movement of a crankshaft that is operably connected to a drive train that is used in the delivery of power to, for example, an output shaft of an associated vehicle, genset, marine propulsion system, mining equipment, or other application.

The intake system 104 may be configured to deliver an air flow, such as, for example, charged air flow to an intake manifold of engine 102. According to certain embodiments, the intake system 104 may also be used in the delivery of fuel to the engine 102, such as, for example, the liquid fuel and/or gaseous fuel. The exhaust system 106 may be configured for the delivery of an exhaust stream that is generated at least in part by the operation of engine 102 to a tailpipe for subsequent release from internal combustion engine system 100. According to certain embodiments, exhaust system 106 is configured for the treatment of the exhaust stream, such as, for example, for the removal or reduction of nitrogen oxide (NOₓ) and particulates in the exhaust stream, and/or the recirculation of the exhaust stream to intake system 104 or to an intake manifold of engine 102.

According to the illustrated embodiment, electrical energy storage system 112 may include a power storage device 114 that provides stored electrical power to internal combustion engine system 100 and components that are part of, or operably connected to, internal combustion engine system 100. A variety of different types of power storage devices 114 may be used, including, for example, one or more electrochemical batteries, super-capacitors, or ultra-capacitors. Additionally, electrical energy storage system 112 may be operably connected to motor system 108. In the illustrated embodiment, motor system 108 may be configured as an electrical motor. Motor system 108 may operate as a motor that is powered by electricity from power storage device 118 to, for example, start internal combustion engine 102. In other embodiments, motor system 108 may also include an electrical motor that starts and/or provide propulsion to a vehicle, and/or functions as an electric power generator that captures electric energy.

The electronic control system 110, which may be configured to control various operational aspects of internal combustion engine system 100, may be implemented in a number of ways. Further, electronic control system (ECS) 110 may include an engine control unit (ECU) 116 configured to execute operating logic that defines various control, management, and/or regulation functions. The operating logic may be in the form of one or more microcontroller or microprocessor routines stored in a non-transitory memory, dedicated hardware, such as a hardwired state machine, analog calculating machine, various types of programming instructions, and/or other forms as would occur to those skilled in the art.

Additionally, electronic control system 110 and/or engine control unit 116 may be provided as a single component, or a collection of operatively coupled components, and may comprise digital circuitry, analog circuitry, or a hybrid combination of both of these types. When of a multi-component form, electronic control system 110 and/or engine control unit 116 may have one or more components remotely located relative to the others in a distributed arrangement. Electronic control system 110 and/or engine control unit 116 can include multiple processing units arranged to operate independently, in a pipeline processing arrangement, in a parallel processing arrangement, or the like. In one embodiment, electronic control system 110 and/or engine control unit 116 includes several programmable microprocessing units of a solid-state, integrated circuit type that are distributed throughout internal combustion engine system 100 that each include one or more processing units and non-transitory memory. For the depicted embodiment, engine control unit 116 includes a computer network interface to facilitate communications using standard Controller Area Network (CAN) communications or the like among various system control units. It should be appreciated that the depicted modules or other organizational units of engine control unit 116 refer to certain operating logic performing indicated operations that may each be implemented in a physically separate controller of engine control unit 116 and/or may be virtually implemented in the same controller.

The description herein including control systems and/or control units emphasizes the structural independence of the aspects of electronic control system 110 and/or engine control unit 116, and illustrates one grouping of operations and responsibilities of electronic control system 110. Other groupings that execute similar overall operations are understood within the scope of the present application. Control systems and/or control units may be implemented in hardware and/or as computer instructions on a non-transient computer readable storage medium and may be distributed across various hardware or computer based components.

Example and non-limiting implementation elements of electronic control system 110 include sensors, such as temperature sensors, engine sensors, and the like, providing any value determined herein, sensors providing any value that is a precursor to a value determined herein, datalink and/or network hardware including communication chips, oscillating crystals, communication links, cables, twisted pair wiring, coaxial wiring, shielded wiring, transmitters, receivers, and/or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), and/or digital control elements.

Electronic control system 110 and/or any of its constituent processors/controllers may include one or more signal conditioners, modulators, demodulators, Arithmetic Logic Units (ALUs), Central Processing Units (CPUs), limiters, oscillators, control clocks, amplifiers, signal conditioners, filters, format converters, communication ports, clamps, delay devices, memory devices, Analog to Digital (A/D) converters, Digital to Analog (D/A) converters, and/or different circuitry or functional components as would occur to those skilled in the art to perform the desired communications.

As shown in FIG. 1, electronic control system 110 and/or engine control unit 116 is operably connected to a variety of components of internal combustion engine system 100, including, for example, engine 102, motor system 108, and/or electrical energy storage system 112. Such connections may allow for the communication of information, data, and/or commands between electronic control system 110 and components of electronic control system 100 that are used in connection the operation and performance of electronic control system 100.

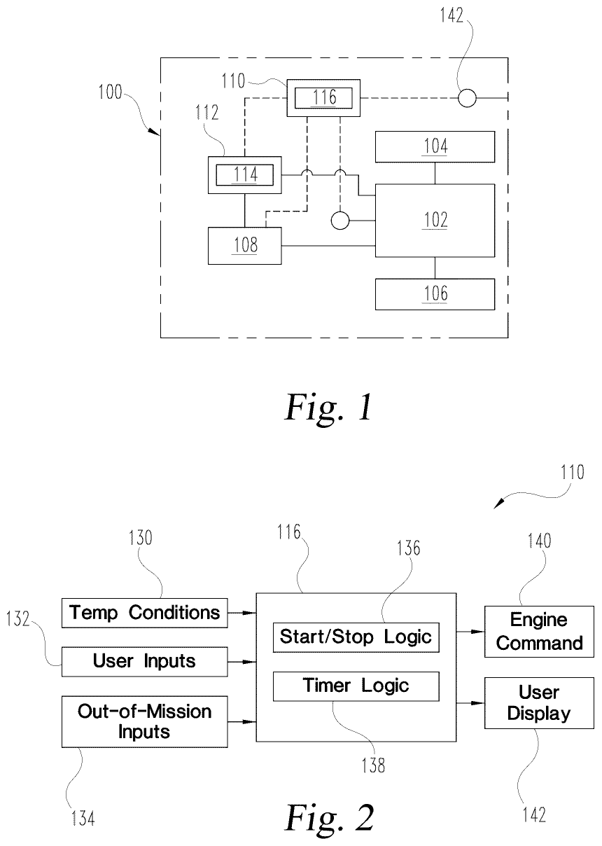

FIG. 2 is a block diagram of an exemplary electronic control system 110 that can be implemented by, for example, engine control unit 116. In the illustrated embodiment, the electronic control system 110 and/or engine control unit 116 may be adapted to control engine 102 automatic restart events and engine automatic shut down events based on start/stop logic 136, one or more temperature condition inputs 130, and a variety of other inputs, conditions, and/or constraints, including, for example, user inputs 132 and engine out-of-mission inputs 134 that indicate whether automatic restarting and shutting down of engine 102 is enabled, prohibited, or otherwise disabled.

A number of forms or implementations of the engine start/stop logic 136 are contemplated. The engine start/stop logic 136 may be adapted to perform a number of operations and tasks, including, for example, determining whether a thermal management condition is present that warrants start/stop control of engine 102 based on an evaluation of temperature condition inputs 130. The engine start/stop control logic 136 may also evaluate temperature condition inputs 130, user inputs 132, and/or out-of-mission inputs 134 with respect to certain criteria for the initiation, suspension, and/or termination of user initiated and/or automatic engine restart or automatic engine shut down commands from the engine control unit 116. The engine start/stop logic 136 additionally may determine whether actual or predicted conditions of the internal combustion engine system 100, including, for example, the engine 102 and/or electrical energy storage system 112, meet certain criteria for the initiation, suspension, and/or termination of user initiated and/or automatic engine restart or automatic engine shut down commands from the engine control unit 116.

For at least purposes of illustration, the engine control unit 116 may include at least start/stop logic 136 and timer logic 138. According to such embodiments, the timer logic 138 may be configured to estimate a restart time for engine 102 based on temperature condition inputs at a key off event and during a thermal management mode of operation. Additionally or alternatively, timer logic 138 may monitor the time that engine 102 is shut down and wake engine control unit 116 from a sleep mode at the estimated restart time to determine whether a restart condition of engine 102 is present.

Engine control unit 116 is also configured to output one or more messages to the user at user display 142. Display 142 can include, for example, a liquid crystal display (LCD), a message, a light, a printout, and/or an audible indicator, indicating it is time to restart engine 102 or to shut down engine 102 when a desired temperature is obtained. Additionally, the amount of time or hours/minutes until restart is required can be displayed. Alternatively, if the user input 132 indicates automatic engine restart is desired, engine control unit 116 can output an engine command 140 to automatically restart engine 102 to increase the engine temperature or to automatically shut down engine 102 when the desired temperature condition has been obtained.

Engine control unit 116 may receive information or data from a variety of components of the internal combustion engine system 100. For example, according to the illustrated embodiment, the electronic control system 110, and in particular the engine control unit 116, may receive temperature condition information from one or more engine sensors 140 and/or one or more ambient temperature sensors 142 that provide information regarding the temperature conditions used for temperature condition inputs 130. Electronic control system 110, and in particular the engine control unit 116, may also receive one or more user inputs, such as an engine restart request, and engine shut down request, and/or a request to operate in an automatic restart mode. Electronic control system 110, and in particular the engine control unit 116, may also receive one or more out-of-mission inputs 134 that indicate engine 102 is out-of-mission and shut down so that the automatic restart mode of operation can be used for thermal management to prevent cold soak conditions without further user input or intervention. The one or more out-of-mission inputs 134 may include, for example, an indication that a load is disconnected from engine 102, that a transmission is disengaged from engine 102, that a parking brake is active, and/or other inputs.

The timer logic 138 may include a real-time timer, counter, and/or summation operation, among other types of information or logic. According to certain embodiments, the timer logic 138 may be a continuous timer or counter, and/or may initiate a timer or counter operation in response to the occurrence of one or more conditions and/or commands from electronic control system 110, electronic control unit 116, and/or engine start/stop logic 136.

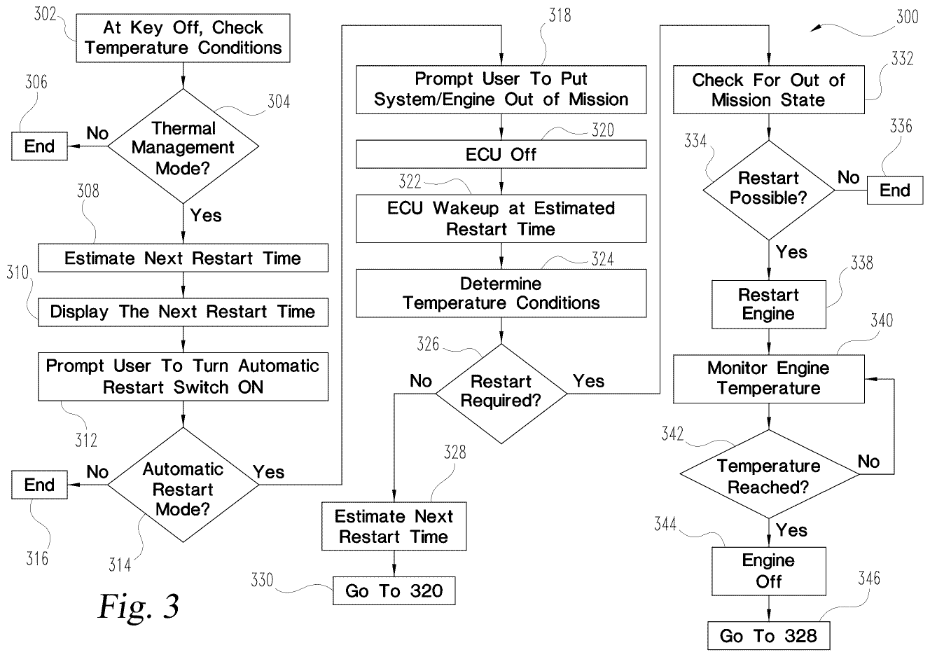

FIG. 3 illustrates a schematic flow diagram of an exemplary method or process 300 for thermally managing engine 102 to prevent or mitigate cold soak conditions in which the temperature of engine 102 drop to or near ambient during a cold weather condition. The operations or steps of process 300 as illustrated are understood to be exemplary only, and operations or steps may be combined or divided, and added or removed, as well as re-ordered in whole or in part.

Process 300 starts at operation 302, such as at a key-off event or other indicator of a shut down of internal combustion engine 102. Process 300 continues at conditional 304 to determine if a thermal management mode of operation is required due to, for example, cold ambient conditions being present. The thermal management mode requirement s can be determined, for example, by comparing ambient temperature with a suitable temperature threshold below which cold soak or other temperature related conditions occur which prevent starting of engine 102 or make starting of engine 102 difficult. If conditional 304 is NO, process 300 ends at 306.

If conditional 304 is YES, process 300 continues at operation 308 to estimate a next engine restart time based on, for example, one or more temperature condition inputs, such as a temperature of engine 102 and/or the ambient temperature at the key off event. In an embodiment, the temperature of engine 102 is determined by oil temperature, coolant temperature, and/or a temperature of some other component or fluid of engine 102. Process 300 continues from operation 308 at operation 310 to display the next restart time for engine 102 to the user. The next restart time can be, for example, output to the user a graphical and/or audible indication of the next engine restart time on, for example, the dashboard of a vehicle, one a control panel, on an LCD, or other device visible and/or audible to the user.

Process 300 continues at operation 312 to prompt the user to activate an automatic restart mode of operation. The automatic restart mode is a mode of operation of electronic control system 110 in which the engine 102 is thermally managed by automatically restarting engine 102 and automatically shutting down engine 102 without user input or action. Process 300 continues from operation 312 at conditional 314 to determine if the automatic restart mode of operation is enabled by the user. If conditional 314 is NO, process ends at 316 and the user manually controls the starting and shutting down of engine 102 for thermal management purposes. In this manual mode of thermal management, the user can be aided by outputs that indicate a restart start time has elapsed, a restart condition for engine 102 is present, and/or a shut down condition for engine 102 is present due to a desired temperature for engine 102 being obtained.

If conditional 314 is YES, the automatic restart mode is initiated and process 300 continues at operation 318 to prompt the user to place internal combustion engine system 100 and/or internal combustion engine 102 in an out-of-mission state. For example, the user can disengage a load, disengage a transmission, activate a parking brake, and/or take other actions to place internal combustion engine system 100 and/or engine 102 in out-of-mission states.

Process 300 then continues at operation 320 to place electronic control system 110, such as engine control unit (ECU) 116, in an OFF state or sleep mode. At operation 322, electronic control system 100 and/or electronic control unit 102 is turned on or “wakes up” from the sleep mode when the estimated restart time determined at operation 308 has been reached.

Process 300 continues from operation 322 at operation 324 to determine one or more temperature conditions at the restart time, such as an ambient temperature and a temperature associated with engine 102. These one or more temperature condition inputs are evaluated at conditional 326 to determine if a restart of engine 102 is required. If conditional 326 is NO, process 300 continues at operation 328 to estimate a next restart time. The next restart time can be based on the temperature condition inputs, such as the engine temperature and the ambient temperature. Process 300 then continues from operation 328 at operation 330, which returns process 300 to operation 320.

If conditional 326 is YES, process 300 continues at operation 332 to check for system 100 and/or engine 102 being in an out-of-mission state. Process 300 continues from operation 332 at conditional 334 to determine if a restart is permitted in view of the out-of-mission state determined at operation 332. If conditional 334 is NO due to internal combustion engine system 100 and/or engine 102 not being in an out-of-mission state due to, for example, the parking brake not being active and/or the transmission being engaged and/or a load being engaged, then process 300 ends at 336.

If conditional 334 is YES, process 300 continues at operation 338 to automatically restart engine 102, such as via a command from electronic control unit 115 to motor system 108. Operation 338 may also include a warning or other indication that an engine restart is about to occur, such as by sounding hooter, blowing a horn, activating an audible indicator, activating a visible alarm, and/or other means.

Process 300 continues from operation 338 at operation 340 to monitor a temperature condition of engine 102. At conditional 342, the temperature condition is evaluated to determine if a desired temperature for internal combustion engine system 100 and/or engine 102 has been reached. If conditional 342 is NO, engine 102 remains running and process 300 returns to operation 340 to continue operating engine 102 to increase the temperature of internal combustion engine system 100 and/or engine 102.

If conditional 342 is YES, process 300 continues at operation 344 to automatically shut down internal combustion engine system 100 and/or engine 102. Process 300 then continues from operation 344 at operation 346, which returns process to operation 328 to determine the next restart time based on one or more temperature conditions associated with internal combustion engine system 100 and/or engine 102. As discussed above, from operation 328 process continues at operation 330 which returns process 300 to operation 320.

Various aspects of the present disclosure are set forth in the following claims. According to one aspect, a method for thermally managing an internal combustion engine system including an electronic control system and an internal combustion engine is provided. The method includes determining, with the electronic control system at a shut down of the internal combustion engine, a restart time for the internal combustion engine based on one or more temperature conditions associated with the internal combustion engine; determining, with the electronic control system, whether a restart requirement for the internal combustion engine is present at the restart time based on one or more temperature conditions associated with the internal combustion engine; in response to the restart requirement being present, automatically restarting the internal combustion engine with the electronic control system; operating the internal combustion engine to obtain a desired engine temperature; and automatically shutting down the internal combustion engine with the electronic control system in response to the desired engine temperature being obtained.

In an embodiment, the method includes determining, with the electronic control system, the internal combustion is in an out-of-mission state before automatically restarting the internal combustion engine.

In an embodiment, the one or more temperature conditions include a temperature of the internal combustion engine and an ambient temperature.

In an embodiment, the temperature of the internal combustion engine is based on one or more of an oil temperature and a coolant temperature.

In an embodiment, the method includes prompting a user to activate an automatic restart mode for the internal combustion after determining the restart time.

In an embodiment, in response to the user not activating the automatic restart mode, the method includes notifying the user with the electronic control system to restart the internal combustion engine at the restart time and to shut down the internal combustion engine when the desired temperature for the internal combustion engine is obtained.

In an embodiment, the method includes, with the electronic control system, prompting the user to place the internal combustion in an out-of-mission state after the user activates the automatic restart mode.

In an embodiment, the electronic control system includes an engine control unit operably connected to the internal combustion engine, and the method includes waking up the electronic control unit at the restart time.

In an embodiment, the method includes determining, with the engine control unit, a second restart time after automatically shutting down the internal combustion engine; and turning the engine control unit off after determining the second restart time.

In an embodiment, the method includes determining, with the electronic control system and before determining the restart time, a thermal management mode is present based at least on an ambient temperature at the shut down of the internal combustion engine.

According to another aspect of the disclosure, an internal combustion engine system is provided. The system includes an internal combustion engine, at least one sensor operable to measure one or more temperature conditions associated with the internal combustion engine, and an electronic control system operably connected to the internal combustion engine and the at least one sensor. The electronic control system is configured to perform operations to at a shut down of the internal combustion engine, establish a restart time for the internal combustion engine based on one or more temperature conditions associated with the internal combustion engine; in response to a restart requirement for the internal combustion engine being present at the restart time based on one or more temperature conditions of the internal combustion, automatically restarting the internal combustion engine in response to the restart requirement being present; operate the internal combustion engine to obtain a desired engine temperature; and automatically shut down the internal combustion engine in response to the desired engine temperature being obtained.

In an embodiment, the electronic control system is configured to perform operations to determine the internal combustion is in an out-of-mission state before the internal combustion engine is automatically restarted.

In an embodiment, the one or more temperature conditions include a temperature of the internal combustion engine and an ambient temperature.

In an embodiment, the electronic control system is configured to perform operations to prompt a user to activate an automatic restart mode for the internal combustion after the restart time is determined.

In an embodiment, the electronic control system is configured to perform operations to prompt the user to place the internal combustion in an out-of-mission state after the user activates the automatic restart mode.

In an embodiment, the electronic control system includes an engine control unit operably connected to the internal combustion engine and the at least one sensor. The electronic control system is configured to perform operations to wake up the electronic control unit at the restart time.

In an embodiment, the electronic control system is configured to perform operations to determine a second restart time after the internal combustion engine is automatically shut down; and turn the engine control unit off after the second restart time is determined.

According to another aspect of the disclosure, an apparatus for thermal management of an internal combustion engine is provided. The apparatus includes an electronic control system including an engine control unit operably connected to the internal combustion engine and to at least one sensor. The engine control unit includes a processor and a memory. The memory includes instructions encoded thereon that cause the processor to perform operations to determine, at a shut down of the internal combustion engine, a restart time for the internal combustion engine based on one or more temperature conditions associated with the internal combustion engine; determine whether a restart requirement for the internal combustion engine is present at the restart time based on one or more temperature conditions of the internal combustion engine; automatically restart the internal combustion engine in response to the restart requirement being present; operate the restarted internal combustion engine to obtain a desired engine temperature; and automatically shut down the internal combustion engine in response to the desired engine temperature being obtained.

In an embodiment, the engine control unit includes instruction encoded on the memory thereof that cause the processor to wake up the electronic control unit at the restart time; determine a second restart time after the internal combustion engine is automatically shut down; and turn the engine control unit off after the second restart time is determined.

In an embodiment, the engine control unit includes instructions encoded on the memory thereof that cause the processor to prompt a user to activate an automatic restart mode for the internal combustion after the restart time is determined; and prompt the user to place the internal combustion in an out-of-mission state after the user activates the automatic restart mode.

Changes and modifications to the described embodiments described herein will be apparent to those skilled in the art, and such changes and modifications can be made without departing from the spirit and scope of the present invention and without diminishing its intended advantages. While the present invention has been illustrated and described in detail in the drawings and foregoing description, the same is to be considered illustrative and not restrictive in character, it being understood that only selected embodiments have been shown and described and that all changes, equivalents, and modifications that come within the scope of the inventions described herein or defined by the following claims are desired to be protected.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method for thermally managing an internal combustion engine system including an electronic control system and an internal combustion engine, the method comprising:
determining, with the electronic control system at a shut down of the internal combustion engine, a restart time for the internal combustion engine based on one or more temperature conditions associated with the internal combustion engine;
determining, with the electronic control system, whether a restart requirement for the internal combustion engine is present at the restart time based on one or more temperature conditions associated with the internal combustion engine;
in response to the restart requirement being present, automatically restarting the internal combustion engine with the electronic control system;
operating the internal combustion engine to obtain a desired engine temperature; and
automatically shutting down the internal combustion engine with the electronic control system in response to the desired engine temperature being obtained.

2. The method according to claim 1, further comprising determining, with the electronic control system, the internal combustion is in an out-of-mission state before automatically restarting the internal combustion engine.

3. The method according to claim 1, wherein the one or more temperature conditions include a temperature of the internal combustion engine and an ambient temperature.

4. The method according to claim 3, wherein the temperature of the internal combustion engine is based on one or more of an oil temperature and a coolant temperature.

5. The method according to claim 1, further comprising prompting a user to activate an automatic restart mode for the internal combustion after determining the restart time.

6. The method according to claim 5, wherein, in response to the user not activating the automatic restart mode, notifying the user with the electronic control system to restart the internal combustion engine at the restart time and to shut down the internal combustion engine when the desired temperature for the internal combustion engine is obtained.

7. The method according to claim 5, further comprising, with the electronic control system, prompting the user to place the internal combustion in an out-of-mission state after the user activates the automatic restart mode.

8. The method according to claim 1, wherein the electronic control system includes an engine control unit operably connected to the internal combustion engine, and further comprising waking up the electronic control unit at the restart time.

9. The method according to claim 8, further comprising:
determining, with the engine control unit, a second restart time after automatically shutting down the internal combustion engine; and
turning the engine control unit off after determining the second restart time.

10. The method according to claim 1, further comprising:
determining, with the electronic control system and before determining the restart time, a thermal management mode is present based at least on an ambient temperature at the shut down of the internal combustion engine.

11. An internal combustion engine system, the system comprising:
an internal combustion engine;
at least one sensor operable to measure one or more temperature conditions associated with the internal combustion engine; and
an electronic control system operably connected to the internal combustion engine and the at least one sensor, the electronic control system configured to perform operations to:
at a shut down of the internal combustion engine, establish a restart time for the internal combustion engine based on one or more temperature conditions associated with the internal combustion engine;
in response to a restart requirement for the internal combustion engine being present at the restart time based on one or more temperature conditions of the internal combustion, automatically restarting the internal combustion engine in response to the restart requirement being present;
operate the internal combustion engine to obtain a desired engine temperature; and
automatically shut down the internal combustion engine in response to the desired engine temperature being obtained.

12. The system according to claim 11, wherein the electronic control system is configured to perform operations to determine the internal combustion is in an out-of-mission state before the internal combustion engine is automatically restarted.

13. The system according to claim 11, wherein the one or more temperature conditions include a temperature of the internal combustion engine and an ambient temperature.

14. The system according to claim 11, wherein the electronic control system is configured to perform operations to prompt a user to activate an automatic restart mode for the internal combustion after the restart time is determined.

15. The system according to claim 14, wherein the electronic control system is configured to perform operations to prompt the user to place the internal combustion in an out-of-mission state after the user activates the automatic restart mode.

16. The system according to claim 11, wherein:
the electronic control system includes an engine control unit operably connected to the internal combustion engine and the at least one sensor; and
wherein the electronic control system is configured to perform operations to wake up the electronic control unit at the restart time.

17. The system according to claim 16, wherein the electronic control system is configured to perform operations to:
determine a second restart time after the internal combustion engine is automatically shut down; and
turn the engine control unit off after the second restart time is determined.

18. An apparatus for thermal management of an internal combustion engine, the apparatus comprising:
an electronic control system including an engine control unit operably connected to the internal combustion engine and to at least one sensor, the engine control unit including a processor and a memory, the memory including instructions encoded thereon that cause the processor to perform operations to:
determine, at a shut down of the internal combustion engine, a restart time for the internal combustion engine based on one or more temperature conditions associated with the internal combustion engine;
determine whether a restart requirement for the internal combustion engine is present at the restart time based on one or more temperature conditions of the internal combustion engine;
automatically restart the internal combustion engine in response to the restart requirement being present;
operate the restarted internal combustion engine to obtain a desired engine temperature; and
automatically shut down the internal combustion engine in response to the desired engine temperature being obtained.

19. The apparatus according to claim 18, the engine control unit includes instruction encoded on the memory thereof that cause the processor to:
wake up the electronic control unit at the restart time;
determine a second restart time after the internal combustion engine is automatically shut down; and
turn the engine control unit off after the second restart time is determined.

20. The apparatus according to claim 18, the engine control unit includes instructions encoded on the memory thereof that cause the processor to:
prompt a user to activate an automatic restart mode for the internal combustion after the restart time is determined; and
prompt the user to place the internal combustion in an out-of-mission state after the user activates the automatic restart mode.
